(19) United States
(12) Patent Application Publication
(10) Pub. No.: US 2005/0087520 A1
(43) Pub. Date: Apr. 28, 2005

(54) Method and apparatus for selective ablation of coatings from medical devices

(76) Inventors: Lixiao Wang, Long Lake, MN (US); Eric B. Stenzel, Galway (IE)

Correspondence Address: KENYON & KENYON, 1500 K STREET, N.W., SUITE 700, WASHINGTON, DC, 20005, US

(21) Appl. No.: 10/694,050

(22) Filed: Oct. 28, 2003

(51) Int. Cl. B23K 26/38

(52) U.S. Cl. 219/121.69; 219/121.83

(57) ABSTRACT

An apparatus and method for selective ablation of therapeutic coating material from the surfaces of generally tubular medical devices, such as stents or guide wires, is provided. The medical device is rotated about its longitudinal axis, and a laser is operated in coordination with the rotational motion of the medical device to ablate a selected portion of the coating from the device, such as a portion of undesired coating. In a further embodiment, laser ablation of the coating on a medical device is conducted to reduce the amount of coating material on the device to a desired target amount of coating.

### FIELD OF THE INVENTION

The present invention is directed to an improved method and apparatus relating to therapeutic and protective coatings on medical devices such as stents.

### BACKGROUND

Medical implants are used for innumerable medical purposes, including the reinforcement of recently re-enlarged lumens, the replacement of ruptured vessels, and the treatment of disease such as vascular disease by local pharmacotherapy, i.e., delivering therapeutic drug doses to target tissues while minimizing systemic side effects. Such localized delivery of therapeutic agents has been proposed or achieved using medical implants which both support a lumen within a patient's body and place appropriate coatings containing absorbable therapeutic agents at the implant location. Examples of such medical devices include catheters, guide wires, balloons, filters (e.g., vena cava filters), stents, stent grafts, vascular grafts, intraluminal paving systems, implants and other devices used in connection with drug-loaded polymer coatings. Such medical devices are implanted or otherwise utilized in body lumina and organs such as the coronary vasculature, esophagus, trachea, colon, biliary tract, urinary tract, prostate, brain, and the like.

The term “therapeutic agent” as used herein includes one or more “therapeutic agents” or “drugs”. The terms “therapeutic agents” and “drugs” are used interchangeably herein and include pharmaceutically active compounds, nucleic acids with and without carrier vectors such as lipids, compacting agents (such as histones), virus (such as adenovirus, andenoassociated virus, retrovirus, lentivirus and α-virus), polymers, hyaluronic acid, proteins, cells and the like, with or without targeting sequences.

Specific examples of therapeutic agents used in conjunction with the present invention include, for example, pharmaceutically active compounds, proteins, cells, oligonucleotides, ribozymes, anti-sense oligonucleotides, DNA compacting agents, gene/vector systems (i.e., any vehicle that allows for the uptake and expression of nucleic acids), nucleic acids (including, for example, recombinant nucleic acids; naked DNA, cDNA, RNA; genomic DNA, cDNA or RNA in a non-infectious vector or in a viral vector and which further may have attached peptide targeting sequences; antisense nucleic acid (RNA or DNA); and DNA chimeras which include gene sequences and encoding for ferry proteins such as membrane translocating sequences (“MTS”) and herpes simplex virus-1 (“VP22”)), and viral, liposomes and cationic and anionic polymers and neutral polymers that are selected from a number of types depending on the desired application. Non-limiting examples of virus vectors or vectors derived from viral sources include adenoviral vectors, herpes simplex vectors, papilloma vectors, adeno-associated vectors, retroviral vectors, and the like. Non-limiting examples of biologically active solutes include anti-thrombogenic agents such as heparin, heparin derivatives, urokinase, and PPACK (dextrophenylalanine proline arginine chloromethylketone); antioxidants such as probucol and retinoic acid; angiogenic and anti-angiogenic agents and factors; anti-proliferative agents such as enoxaprin, angiopeptin, rapamycin, monoclonal antibodies capable of blocking smooth muscle cell proliferation, hirudin, and acetylsalicylic acid; anti-inflammatory agents such as dexamethasone, prednisolone, corticosterone, budesonide, estrogen, sulfasalazine, acetyl salicylic acid, and mesalamine; calcium entry blockers such as verapamil, diltiazem and nifedipine; antineoplastic/antiproliferative/anti-mitotic agents such as paclitaxel, 5-fluorouracil, methotrexate, doxorubicin, daunorubicin, cyclosporine, cisplatin, vinblastine, vincristine, epothilones, endostatin, angiostatin and thymidine kinase inhibitors; antimicrobials such as triclosan, cephalosporins, aminoglycosides, and nitorfurantoin; anesthetic agents such as lidocaine, bupivacaine, and ropivacaine; nitric oxide (NO) donors such as lisidomine, molsidomine, L-arginine, NO-protein adducts, NO-carbohydrate adducts, polymeric or oligomeric NO adducts; anti-coagulants such as D-Phe-Pro-Arg chloromethyl ketone, an RGD peptide-containing compound, heparin, antithrombin compounds, platelet receptor antagonists, anti-thrombin antibodies, anti-platelet receptor antibodies, enoxaparin, hirudin, Warafin sodium, Dicumarol, aspirin, prostaglandin inhibitors, platelet inhibitors and tick antiplatelet factors; vascular cell growth promoters such as growth factors, growth factor receptor antagonists, transcriptional activators, and translational promoters; vascular cell growth inhibitors such as growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and a cytotoxin; cholesterol-lowering agents; vasodilating agents; agents which interfere with endogeneus vascoactive mechanisms; survival genes which protect against cell death, such as anti-apoptotic Bcl-2 family factors and Akt kinase; and combinations thereof. Cells can be of human origin (autologous or allogenic) or from an animal source (xenogeneic), genetically engineered if desired to deliver proteins of interest at the insertion site. Any modifications are routinely made by one skilled in the art.

Polynucleotide sequences useful in practice of the invention include DNA or RNA sequences having a therapeutic effect after being taken up by a cell. Examples of therapeutic polynucleotides include anti-sense DNA and RNA; DNA coding for an anti-sense RNA; or DNA coding for tRNA or rRNA to replace defective or deficient endogenous molecules. The polynucleotides can also code for therapeutic proteins or polypeptides. A polypeptide is understood to be any translation product of a polynucleotide regardless of size, and whether glycosylated or not. Therapeutic proteins and polypeptides include as a primary example, those proteins or polypeptides that can compensate for defective or deficient species in an animal, or those that act through toxic effects to limit or remove harmful cells from the body. In addition, the polypeptides or proteins that can be injected, or whose DNA can be incorporated, include without limitation, angiogenic factors and other molecules competent to induce angiogenesis, including acidic and basic fibroblast growth factors, vascular endothelial growth factor, hif-1, epidermal growth factor, transforming growth factor a and β, platelet-derived endothelial growth factor, platelet-derived growth factor, tumor necrosis factor α, hepatocyte growth factor and insulin like growth factor; growth factors; cell cycle inhibitors including CDK inhibitors; anti-restenosis agents, including p15, p16, p18, p19, p21, p27, p53, p57, Rb, nFkB and E2F decoys, thymidine kinase (“TK”) and combinations thereof and other agents useful for interfering with cell proliferation, including agents for treating malignancies; and combinations thereof. Still other useful factors, which can be provided as polypeptides or as DNA encoding these polypeptides, include monocyte chemoattractant protein (“MCP-1”), and the family of bone morphogenic proteins (“BMP's”). The known proteins include BMP-2, BMP-3, BMP-4, BMP-5, BMP-6 (Vgr-1), BMP-7 (OP-1), BMP-8, BMP-9, BMP-10, BMP-11, BMP-12, BMP-13, BMP-14, BMP-15, and BMP-16. Currently preferred BMP's are any of BMP-2, BMP-3, BMP-4, BMP-5, BMP-6 and BMP-7. These dimeric proteins can be provided as homodimers, heterodimers, or combinations thereof, alone or together with other molecules. Alternatively or, in addition, molecules capable of inducing an upstream or downstream effect of a BMP can be provided. Such molecules include any of the “hedgehog” proteins, or the DNA's encoding them.

Coatings used with the present invention may comprise a polymeric material/drug agent matrix formed, for example, by admixing a drug agent with a liquid polymer, in the absence of a solvent, to form a liquid polymer/drug agent mixture. Curing of the mixture typically occurs in-situ. To facilitate curing, a cross-linking or curing agent may be added to the mixture prior to application thereof Addition of the cross-linking or curing agent to the polymer/drug agent liquid mixture must not occur too far in advance of the application of the mixture in order to avoid over-curing of the mixture prior to application thereof. Curing may also occur in-situ by exposing the polymer/drug agent mixture, after application to the luminal surface, to radiation such as ultraviolet radiation or laser light, heat, or by contact with metabolic fluids such as water at the site where the mixture has been applied to the luminal surface. In coating systems employed in conjunction with the present invention, the polymeric material may be either bioabsorbable or biostable. Any of the polymers described herein that may be formulated as a liquid may be used to form the polymer/drug agent mixture.

In a certain embodiment, the polymer used to coat the medical device may be provided in the form of a coating on an expandable portion of a medical device. After applying the drug solution to the polymer and evaporating the volatile solvent from the polymer, the medical device is inserted into a body lumen where it is positioned to a target location. In the case of a balloon catheter, the expandable portion of the catheter is subsequently expanded to bring the drug-impregnated polymer coating into contact with the lumen wall. The drug is released from the polymer as it slowly dissolves into the aqueous bodily fluids and diffuses out of the polymer. This enables administration of the drug to be site-specific, limiting the exposure of the rest of the body to the drug.

The polymer is preferably capable of absorbing a substantial amount of drug solution. When applied as a coating on a medical device, the dry polymer is typically on the order of from about 1 to about 50 microns thick. In the case of a balloon catheter, the thickness is preferably about 1 to 10 microns thick, and more preferably about 2 to 5 microns. Very thin polymer coatings, e.g., of about 0.2-0.3 microns and much thicker coatings, e.g., more than 10 microns, are also possible. It is also within the scope of the present invention to apply multiple layers of polymer coating onto a medical device. Such multiple layers are of the same or different polymer materials.

The polymer of the present invention may be hydrophilic or hydrophobic, and may be selected from the group consisting of polycarboxylic acids, cellulosic polymers, including cellulose acetate and cellulose nitrate, gelatin, polyvinylpyrrolidone, cross-linked polyvinylpyrrolidone, polyanhydrides including maleic anhydride polymers, polyamides, polyvinyl alcohols, copolymers of vinyl monomers such as EVA, polyvinyl ethers, polyvinyl aromatics, polyethylene oxides, glycosaminoglycans, polysaccharides, polyesters including polyethylene terephthalate, polyacrylamides, polyethers, polyether sulfone, polycarbonate, polyalkylenes including polypropylene, polyethylene and high molecular weight polyethylene, halogenated polyalkylenes including polytetrafluoroethylene, polyurethanes, polyorthoesters, proteins, polypeptides, silicones, siloxane polymers, polylactic acid, polyglycolic acid, polycaprolactone, polyhydroxybutyrate valerate and blends and copolymers thereof as well as other biodegradable, bioabsorbable and biostable polymers and copolymers. Coatings from polymer dispersions such as polyurethane dispersions (BAYHDROL®, etc.) and acrylic latex dispersions are also within the scope of the present invention. The polymer may be a protein polymer, fibrin, collage and derivatives thereof, polysaccharides such as celluloses, starches, dextrans, alginates and derivatives of these polysaccharides, an extracellular matrix component, hyaluronic acid, or another biologic agent or a suitable mixture of any of these, for example. In one embodiment of the invention, the preferred polymer is polyacrylic acid, available as HYDROPLUS® (Boston Scientific Corporation, Natick, Mass.), and described in U.S. Pat. No. 5,091,205, the disclosure of which is hereby incorporated herein by reference. U.S. Pat. No. 5,091,205 describes medical devices coated with one or more polyisocyanates such that the devices become instantly lubricious when exposed to body fluids. In another preferred embodiment of the invention, the polymer is a copolymer of polylactic acid and polycaprolactone.

The delivery of stents is a specific example of a medical procedure that involves the deployment of coated implants. Stents are tube-like medical devices designed to be placed within the inner walls of a lumen within the body of a patient. Stents typically have thin walls formed from a lattice of stainless steel, Tantalum, Platinum or Nitinol alloys. The stents are maneuvered to a desired location within a lumen of the patient's body, and then typically expanded to provide internal support for the lumen. Stents may be self-expanding or, alternatively, may require external forces to expand them, such as by inflating a balloon attached to the distal end of the stent delivery catheter.

The mechanical process of applying a coating onto a medical device may be accomplished in a variety of ways. For example, the device may be held stationary while the coating composition is sprayed onto the surface of the device. Alternatively, medical devices such as stents may also be coated by so-called spin-dipping, i.e., dipping a spinning stent into a coating solution to achieve the desired coating. It is also known to employ electrohydrodynamic fluid deposition with electrically conductive medical devices, i.e., applying an electrical potential difference between a coating fluid and the target medical device to cause coating fluid discharged from the dispensing point to be drawn toward the target device.

### SUMMARY OF THE INVENTION

There is a need for an apparatus and method for highly selective removal of a therapeutic coating material from the surfaces of small, generally tubular medical devices, such as stents. There is a further need that the apparatus and method be suitable for use in a highly automated, high-speed production environment. It is desirable to have an apparatus and method that can provide the stent or other device with areas of removed coating and/or can remove coating to bring the amount of coating to within a desired range.

There is a provided in a first embodiment of the present invention a fixture for holding a generally tubular medical device coated with a therapeutic material and rotating the medical device about an axis through the device. The motion of the rotating medical device is controlled by a motion controller. The rotation is coordinated with a laser controller. The medical device may be a coated stent, and the laser controller may be programmed with the structural configuration of the stent, which it uses in conjunction with stent orientation information to command a laser aimed at the rotating medical device to fire pulses of laser light energy in a predetermined pattern. This predetermined pattern causes laser light energy to be directed only on a predetermined selected portion of the medical device structure, while avoiding undesired light energy directed at other portions of the device. The laser controller further controls the parameters of the laser pulse emission to ensure the amount of laser light energy directed at the selected portion is evenly distributed throughout the selected portion, and is sufficient to ablate all of the coating on the target surfaces of the medical device. As the laser completes ablation of coating from the portion of the rotating stent in line with the laser beam path, the stent and/or the laser are repositioned to permit the next portion of coating to be removed. This process continues until the selected portion of coating has been completely removed from the medical device.

A further embodiment of the present invention employs the apparatus to selectively ablate only as much of the coating from the medical device as is required to reduce the amount of coating composition on the device to a target coating amount. As a first step, the amount of coating material present on the coated device is determined, for example by weighing the coated stent before the laser ablation process and subtracting a predetermined nominal stent weight. The target weight of the coating is subtracted from the measured coating weight to determine an amount of coating that must be removed from the coated stent in order to achieve the desired target coating amount. The laser controller then commands the laser to ablate coating from the rotating medical device in a predetermined pattern until the laser has removed the coating material from an amount of surface area corresponding to the previously calculated weight of coating to be removed.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a perspective view of a stent from which a selected portion of a coating material is to be ablated in accordance with an embodiment of the present invention.

FIGS. 2A and 2B are oblique views of a lattice link of the stent of FIG. 1, illustrating, respectively a coating layer thereon prior to and following coating removal in accordance with an embodiment of the present invention.

FIG. 3 is a schematic illustration of a laser ablating apparatus in accordance with an embodiment of the present invention.

FIG. 4 is a schematic illustration of a variation of the arrangements of the laser ablating apparatus in accordance with an embodiment of the present invention.

FIG. 5 is an oblique view of the lattice link of FIG. 2A following selective ablation of a portion of the coating for reduction of coating to a target coating amount in accordance with an embodiment of the present invention.

### DETAILED DESCRIPTION

Some possible embodiments of the invention are hereafter described. FIG. 1 is an oblique view of a tubular stent 1 which has received a coating of a therapeutic material. As shown in the figure, stent 1 is formed in a generally cylindrical shape, with a lattice of links 2 of a material such as stainless steel, Tantalum, Platinum or Nitinol alloys. In this embodiment, it is desired that a selected portion 3 of the stent 1 not be coated. The selected portion 3 is identified in FIG. 1 as the region between the dashed line 4 and a first end 5 of the stent. The selected portion may be, for example, the ends of the stent, the central portion of the stent, the inner surface of the stent, or any other portion from where it may be desired to remove coating.

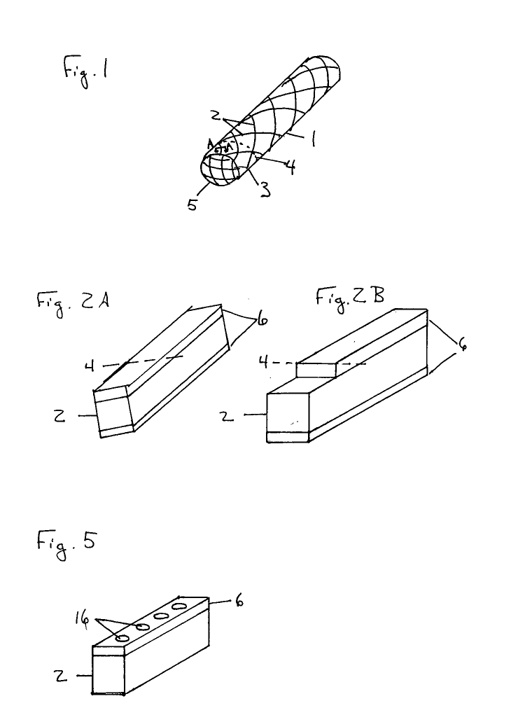

FIG. 2A is an oblique view of a cross-section of a lattice link of stent 1 taken at section A-A in FIG. 1, with dashed line 4 again indicating the boundary of the desired coating removal region 3. A portion of the stent lattice link 2 at section A-A is shown with a therapeutic coating layer 6 formed by prior spray deposition of a coating composition. For clarity, coating material is illustrated only on the outer and inner surfaces of lattice link 2, however, it will be appreciated that there may be coating configurations in which the sides of lattice link 2 are also coated, as might be the case if lattice link 2 was completely encapsulated in a coating application technique such as spin-dipping. FIG. 2B illustrates the result after laser ablation with the present invention, wherein the coating has been removed from the portion of the outer surface of lattice link 2 within region 3.

The apparatus used to selectively ablate the coating material in region 3 of stent 1 in accordance with some embodiments of the invention is described as follows. As shown in FIG. 3, stent 1 has been placed on a stent holder 7 and is retained on holder 7 by a retaining bar 8. The stent holder may be one of a variety of stent holders designs, as long as the stent holder does not substantially interfere with the ablation of coating from the selected target areas on the stent. Preferably, the stent holder is a design suitable for high speed automated stent processing, such as the shaped-wire stent holders described in U.S. patent application Ser. No. 10/198094, in order to facilitate use of the present invention in an automated stent manufacturing facility. Further, in order to minimize stent handling during a multi-step automated stent manufacturing process, stent 1 may be introduced to a laser ablation portion of the manufacturing process on same stent holder 7 on which it was previously held for coating application and coating drying.

Stent holder 7 is mounted on a stent holder rotating mechanism 9, which in this embodiment is an electric motor drive mechanism that rotates holder 7 and stent 1 in response to motor control commands issued by stent motion controller 10. Rotating mechanism 9 may optionally be mounted in base 11 that is capable of orienting the rotating mechanism 9 and stent 1 about more than one axis and extending or retracting stent 1 along its longitudinal axis relative to rotating mechanism 9. This optional stent orientation and position adjustment capability also may be controlled by motion controller 10. Motion controller 10 may be, for example, a general purpose computer programmed to control stent rotation and stent holder orientation. Exemplary equipment includes rotary positioning system model number GR-XA Crossed Roller Stage available from Anorad Corporation of Shirley, N.Y., or rotary positioning system model number ADR175/ADR240 Series Rotary Table available from Aerotech, Inc. of Pittsburgh, Pa.

Preferably, stent holder 7 and/or rotating mechanism 9 are adapted to ensure stent 1 is mounted in a manner that indexes the stent structure relative to a reference point in order to ensure the stent is properly aligned to receive subsequent laser pulses in the desired target areas. In the present example, at the ends of the stent the lattice links of stent 2 are arranged in a zigzag or serpentine pattern, with “v”-shaped or “u”-shaped valleys at the ends of the stent. When stent 1 is held by stent holder 7 and retaining bar 8, the retaining bar's arms enter the v-shaped or u-shaped valleys at the end of the stent and press against the lattice structure. Retaining bar 8, which cooperates with holder 7 to maintain a predetermined position relative to the holder, causes the stent to positively rotate into a predetermined position relative to holder 7. Stent holder 7 is in turn keyed to provide a predetermined alignment with rotating mechanism 9. In this manner, the precise location of the structural elements of the medical device may be reliably established without time-consuming individual device orientation calibration steps, further enhancing automated production throughput rates.

In addition to the stent rotating and orienting apparatus, there is provided a laser and laser orienting mechanism to permit application of laser light energy to the desired target areas on the stent. In FIG. 3, laser 12 is mounted in a laser mounting base 13. In this first embodiment, laser 12 is held in a fixed orientation relative to the longitudinal axis of stent 1, such that the light energy emitted from the laser will strike the selected portion 3 of stent 1 from which the coating composition is to be removed when these stent lattice links 2 rotate through the laser light path. The laser in this embodiment is an xenon chloride (XeCl) excimer laser operating in the UV range. Exemplary equipment includes a model IPEX 800 series excimer laser system available from GSI Lumonics of Billerica, Mass. Satisfactory coating ablation performance has been observed with the laser operating on XeCl transition at 308 nm in a pulse mode with a repetition rate of approximately 200 firings per second (i.e., about 200 Hz), power level at approximately 40 Watts, and approximately 20 pulses of laser light energy deposited at each location within the selected ablation portion covered by the laser beam at a 5:1 demagnification. It will be appreciated that these laser operating parameters may be varied considerably, for example, by use of a krypton fluoride (KrFl) laser operating at 248 nm, or other lasers, such as YAG or CO₂ lasers, as long as the laser can achieve the desired coating removal without significant damage to adjacent portions of the coating or the medical device itself.

The operation of laser 12 is controlled by a laser controller 14, which controls the timing and duration of the firing of light pulses from laser 12. Laser controller 14 communicates with stent motion controller 10 via link 15. Position sensors within stent rotating mechanism 9 and base 11 (not shown) provide stent orientation and position information via motion controller 10 and link 15 to laser controller 14. In this embodiment, motion controller 10 and laser controller 14 are shown as separate components; however they may be integrated into a multi-function controller, such as an appropriately-programmed general purpose computer. Laser controller 14 may also optionally control laser mounting base 13 to control the position and orientation of laser 12 about more than one axis if base 13 is so equipped. One advantage of laser mounting base 13 being equipped to rotate and translate laser 12 relative to stent 1 is that it provides the ability to have laser controller 14 command repositioning of the laser without manual laser repositioning and aiming recalibration. This permits automated laser repositioning without significant production interruption, facilitating rapid laser movement to ablate coating from multiple areas on a stent or to accommodate different medical device configurations with different ablation patterns on the same stent production line.

The method of use of an example of an embodiment of the present invention method is as follows. Stent I on stent holder 7 is rotated by rotating mechanism 9 in accordance with commands issued by stent motion controller 10. In this embodiment, the stent may be rotated at a constant angular velocity of 100 rotations per minute. Information describing the position of rotating stent 1 is provided from stent motion controller 10 to laser controller 14. Laser controller 14, which is programmed with the configuration of stent 1, controls the firing of laser 12 in coordination with the stent position information provided by motion controller 10 to cause the light pulses emitted from laser 12 to arrive at the surface of coating 6 as each lattice link 2 within the selected portion 3 passes through the axis of the laser light beam. In this manner, laser controller 14 causes laser 12 to deposit light energy only on the portions of coating 6 to be ablated, without ablating coating in regions behind or adjacent to the target areas, such as on the inner surface of the stent, as would occur if a continuous laser light beam were employed. Laser controller 14 continues pulsed laser firing as each lattice link within the selected portion passes through the laser's field until a predetermined laser energy dose sufficient to remove the coating in the target area has been applied to each lattice link at the intersection of the laser beam path and the rotating stent. The coordinated laser firing to ablate coating material continues as the stent 1 is further advanced along its longitudinal axis to place additional portions of lattice links 2 within selected portion 3 into the laser beam path. As stent 1 is moved along its longitudinal axis, the change in stent longitudinal position is communicated to laser controller 14 to permit the laser controller, which has been programmed with the structural configuration of stent 1, to alter the laser pulse firing pattern (e.g., pulse timing) to ensure the laser light continues to be deposited only on the target areas of coating 6 on the lattice links. Thus, laser controller 14 can adjust the laser firing timing and other firing parameters to accommodate non-linear medical device surface contours, such as a curved, diagonal stent lattice link, to continue to ablate coating only from the desired target areas as stent 1 rotates. The rotation and advance of stent 1 is continued until the desired coating ablation has been completed across the entire selected portion of the stent, as shown in FIG. 2B, where coating 6 has been removed up to the edge of region 3 illustrated by dashed line 4.

The foregoing method permits automated selected ablation of coating material from rotating medical devices with great precision and at very high production rates, even with medical devices having highly complex three-dimensional surfaces and very small elements, such as stent lattice links. Initial calculations of coating removal from coated stents have shown that ablation rates of 0.0377 in² per minute are achievable. Thus, the coating on the entire outer layer of an average size stent, for example, may have its coating ablated with high precision in less than 4 minutes.

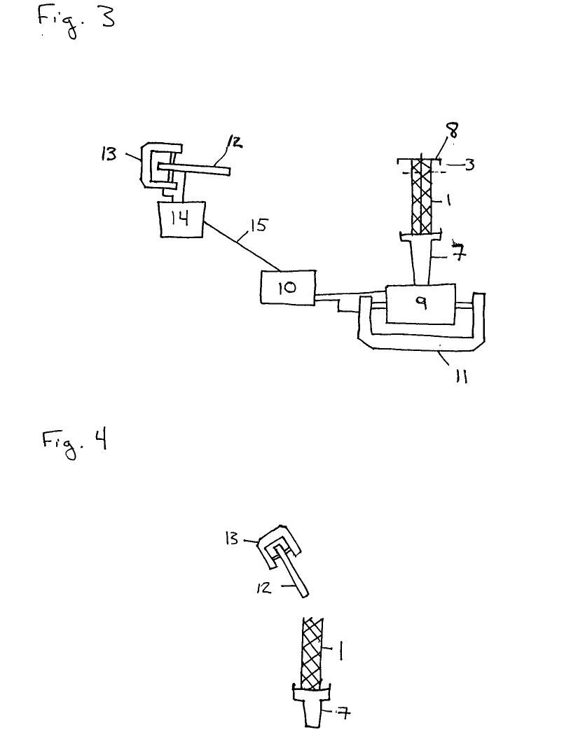

It will be readily appreciated that the details of the foregoing embodiments may be modified in a variety of ways while keeping within the scope of the present invention. For example, if, instead of ablating coating from the outer surface of the medical device, it is desired to ablate coating from an inner surface of the device that can be reached by the laser light, such as the inner surface of stent lattice links 2, the controller 14 may be programmed to translate and reorient laser 12 into a position that permits the laser light to reach the target areas of the inner surface, and alter the laser light firing parameters to ensure deposition of the sufficient light energy to completely ablate the coating on all of the selected portion. Such reprogramming may include realigning the laser to fire into an end of the stent, as shown in FIG. 4, or altering the laser firing commands to cause the laser light pulses to pass between lattice links on the side of the stent nearest the laser to then impinge on the inner surface of the lattice links on the side of the stent farthest from the laser.

In another variation, rotating mechanism 9 may be controlled by motion controller 10 to vary the rotational velocity of stent 1 and/or angular displacement of the stent relative to an index position, to permit coordinated operation of laser 12 for ablation of coating from the medical device in accordance with a complex ablation pattern, for example to ensure unique or asymmetric device contours are adequately ablated.

A further variation provides for laser controller 14 to alter the position and orientation of the laser, rather than moving stent 1 along its longitudinal axis, to cause the light energy emitted by laser 12 to ablate the coating on all of the surface of the selected ablation portions.

Further possible embodiments of the present invention employ the apparatus described above in a manner that ablates coating material from a sufficient portion of the surface of the coated medical device to yield a total amount of coating remaining on the stent at a target coating amount. In this embodiment, a stent is weighed prior to its being placed into position before ablating laser 12. By subtracting the weight of the stent (either a predetermined nominal weight for all stents of the same type or a weight determined from a pre-coating weighing of the stent) and the desired target weight of the stent coating from the measured total weight of the coated stent, a target amount of coating to be removed from the stent may be determined. This determination may be performed by a separate calculating device (not illustrated) or by one of the above-described controllers, such as laser controller 14, in accordance with appropriate programming. From the target amount of coating, an amount of surface area of coating composition to be removed from the stent may be simply calculated using nominal coating thickness and density values.

Once the amount of surface area of coating to be ablated from the stent has been determined, motion controller 10 and laser controller 14 may be operated to cause laser 12 to ablate a selected portion of the coating, where the selected portion includes the amount of surface area corresponding to the surface area required to be removed to reach the target coating weight, distributed over the surface of the stent coating in accordance with a predetermined pattern. For example, laser controller 14 may be programmed to remove coating material from the outer surface of the stent lattice links starting from a first end of the stent and progressing toward the other end until sufficient coating has been removed to achieve the target coating weight. Alternatively, the desired amount of coating ablation may be distributed over a plurality of surfaces on the medical device. Moreover, the ablation pattern need not be limited to complete ablation of the coating material within a region of the stent coating, but may include the use of laser 12 with highly focussed laser beam pulses to ablate small holes in the coating on individual lattice links, such as the pattern of holes 16 shown in coating 6 in FIG. 5 (illustrating only the outer surface coating layer). The selected ablation to achieve the target coating weight could also be performed in a manner that varies the spot dosage of therapeutic material delivered by the finished device, for example, by ablating coating from the middle of the device rather than the ends to provide maximum dosage in the regions near the ends of the device.

As with the other embodiments of the present invention, a number of further variations within the scope of the present invention may be readily envisioned. For example, rotation of the medical device and/or the laser firing pattern may be altered to provide for asymmetric coating ablation from the device if needed or desired for the anticipated application within a patient. As an alternative to the foregoing laser and stent rotation arrangements, the laser may be mounted on a translation and reorientation mechanism that permits the laser to be rotated about a stent held in a fixed position and orientation, rather than rotating the stent, to achieve the same relative motion between the ablating laser and the stent. The method and apparatus for determining the coated stent weight may also be varied. For example, rather than directly weighing the coated stent, the coating weight may be estimated from measured coating sprayer activation duration or by other non-invasive means, such as coating thickness detectors.

Further, to improve the uniformity of coated stent production yield, the coated stents deliberately may be provided with an excess of coating material above the desired target amount. Due to process and statistical variations, when a coating process is designed to provide a target amount of coating to a medical device, a certain fraction of the produced coated devices may contain an insufficient amount of coating. The combination of raising the nominal amount of coating to be applied to a level which essentially eliminates underweight coated product, with the present laser ablation technique which essentially eliminates overweight coated product, the uniformity of coated medical devices, and thus the amount of therapeutic dose delivered to the patient, is substantially enhanced.

A further enhancement of the present invention would include the use of a pattern recognition system that could identify the positioning of the stent struts relative to the laser and thereby identify mis-positioned stents. If the pattern recognition system determined that the stent struts were not in an optimal position relative to the laser to ensure accurate, high quality ablation on the individual stent struts, the output of the pattern recognition system could be used to provide corrections to the controllers to alter the stent position relative to the laser. For example, in response to the pattern recognition system output, the motion controller may command further rotation of the stent to bring stent struts into a preferred position relative to the laser. Alternatively, the laser controller, in response to the pattern recognition system output, may alter the laser light distribution pattern and/or command the motion controller to modify its stent rotation pattern. Either of these example approaches to employment of the pattern recognition system would permit automatic correction of stent position errors to improve the accuracy and quality of the stent coating ablation.

While the present invention has been described with reference to what are presently considered to be preferred embodiments thereof, it is to be understood that the present invention is not limited to the disclosed embodiments or constructions. On the contrary, the present invention is intended to cover various modifications and equivalent arrangements. For example, the motion controller may be coupled to a pattern recognition system that permits the controller to self-adjust the position of the stent whose struts may be out of slightly a desired position for laser ablation. In addition, while the various elements of the disclosed invention are described and/or shown in various combinations and configurations, which are exemplary, other combinations and configurations, including more, less or only a single embodiment, are also within the spirit and scope of the present invention.

1. A method for removal of a selected portion of a therapeutic coating from a coated generally tubular medical device, comprising the steps of:
rotating the medical device relative to a coating removal laser; and
ablating the selected portion of the coating from the rotating medical device with the laser.

2. The selective coating removal method of claim 1, wherein
the laser is controlled by a laser controller to distribute light energy over the selected portion, and
an amount of light energy distributed by the laser is sufficient to ablate the selected portion of the coating from the medical device.

3. The selective coating removal method of claim 2, wherein
the rotation of the medical device relative to the laser is controlled by a motion controller, and
the laser controller cooperates with the motion controller to control the laser to distribute light energy on the selected portion of the coating.

4. The selective coating removal method of claim 3, wherein
the laser controller controls the laser in accordance with a predetermined pattern as the medical device is rotated relative to the laser.

5. The selective coating removal method of claim 4, wherein the selected portion comprises a plurality of coating sections on the medical device.

6. The selective coating removal method of claim 5, wherein the selected portion comprises at least one circular coating section.

7. The selective coating removal method of claim 4, wherein the medical device is a stent.

8. The selective coating removal method of claim 4, further comprising:
a pattern recognition system which detects stent strut position relative to the laser, wherein
at least one of the stent strut position relative to the laser and the laser light distribution is altered in response to the detected stent strut position relative to the laser to improve ablation accuracy.

9. The selective coating removal method of claim 3, further comprising the step of:
determining an amount of coating on the medical device prior to selective coating removal,
wherein the selected portion of the coating to be removed is a portion of the coating sufficient to reduce the amount of coating on the medical device to a target amount of coating.

10. The selective coating removal method of claim 9, wherein
the target amount of coating is a target weight of coating, and
the step of determining the amount of the coating on the medical device prior to selective coating removal comprises subtracting a weight of the medical device from the weight of the coated medical device.

11. The selective coating removal method of claim 10, wherein the selected portion is at least one circular coating section.

12. The selective coating removal method of claim 11, wherein the medical device is a stent.

13. A selective coating removal apparatus for removal of a selected portion of a coating from a coated medical device, comprising:
a medical device rotator; and
a laser,
wherein the laser ablates the selected portion of the coating from the medical device as the medical device is rotated by the rotator.

14. The selective coating removal apparatus of claim 12, further comprising:
a laser controller, wherein
the laser controller causes the laser to distribute light energy over the selected portion, and
an amount of light energy distributed by the laser is sufficient to ablate the selected portion of the coating from the medical device.

15. The selective coating removal apparatus of claim 14, further comprising:
a motion controller, wherein
the motion controller controls the rotation of the medical device relative to the laser, and
the laser controller cooperates with the motion controller to control the laser to distribute light energy on the selected portion of the coating.

16. The selective coating removal apparatus of claim 15, wherein the selected portion comprises a plurality of coating sections on the medical device.

17. The selective coating removal method of claim 16, wherein the selected portion comprises at least one circular coating section.

18. The selective coating removal apparatus of claim 15, wherein the medical device is a stent.

19. The selective coating removal apparatus of claim 15, wherein the selected portion of the coating to be removed is a portion of the coating sufficient to reduce the amount of coating on the medical device to a target amount of coating.

20. The selective coating removal apparatus of claim 19, wherein
the target amount of coating is a target weight of coating.

21. The selective coating removal method of claim 20, wherein the selected portion is at least one circular coating section.

22. The selective coating removal method of claim 21, wherein the medical device is a stent.
